(19) United States
(12) Patent Application Publication
(10) Pub. No.: US 2005/0117550 A1
(43) Pub. Date: Jun. 2, 2005

(54) Information processing device

(75) Inventor: Takashi Matsumura, Kanagawa (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/965,241

(22) Filed: Oct. 14, 2004

(30) Foreign Application Priority Data
Oct. 17, 2003 (JP) P. 2003-357784

(51) Int. Cl. H04B 7/216

(52) U.S. Cl. 370/335; 370/342

(57) ABSTRACT

CPU executes various processes which can be executed by an information processing device. A communication module executes a communication process using the EV-DO standard or the cdma2000 1x standard. A connection terminal serves as a coupling connector for an asynchronous serial communication signal line through which subscriber information is written. A switch section and an in-module switch section can select connection between the CPU and the communication module or between the connection terminal and the communication module. A switch switches when a user selects the object to be connected in the switch section and the in-module switch section. A display unit displays mainly the processing result by the CPU. A notification section is e.g. an LED controlled by the communication module.

### BACKGROUND OF THE INVENTION

1. Field of the Invention

The present invention relates to an information processing device and in particular to an information processing device having a communication function.

2. Description of the Related Art

Recently, cdma2000 1xEV-DO (hereinafter referred to as EV-DO) has been developed as a next-generation high-rate radio communication system. The EV-DO is a new version of specializing cdma2000 1x system provided by expanding cdma2000 to the third-generation system for data communications and increasing the transmission rate. “EV” means Evolution, and “DO” means Data Only.

The EV-DO system is approximately the same as the cdma2000 1x system in the configuration of a radio interface of an upstream channel from a radio communication terminal to a base station. As for the configuration of the radio interface of a downstream channel from a base station to a radio communication terminal, whereas the bandwidth of 1.23 MHz is the same with that of the cdma2000 1x system, the modulation method and the multiplexing method are much different from those of the cdma2000 1x system. As for the modulation method, whereas QPSK and HPSK are used in the cdma2000 1x system, QPSK, 8-PSK, or 16QAM is selectively used in the EV-DO system according to a reception state of a downstream channel of a radio communication terminal. As a result, a high transmission rate with low error resistance is used when the reception state is good, and a low transmission rate with high error resistance is used when the reception state is bad.

As for the multiplexing method for enabling multiple communications from one base station to a plurality of radio communication terminals, TDMA (Time Division Multiple Access) is employed in which communications with a plurality of radio communication terminals are performed in such a manner that time is divided in units of 1/600 second, a communication is performed with one radio communication terminal in each unit time, and the radio communication terminal to be communicated is switched every unit time, rather than CDMA (Code Division Multiple Access) which is employed in the cdmaOne system and the cdma2000 1x system.

A radio communication terminal measures a carrier-to-interference power ratio (hereinafter abbreviated as CIR) of a pilot signal as an index of a reception state of a downstream channel from a base station to be communicated, predicts a reception state during the next reception time slot on the basis of a variation of the CIR, and notify “a maximum transmission rate which enables to receive with a error ratio that is lower than a predetermined rate”, which is expected from the predicted reception state to the base station as data rate control bits (hereinafter referred to as DRC)predetermined. The predetermined error rate is usually set to about 1% though it depends on the system design. The base station receives the DRCs from a plurality of radio communication terminals, and a scheduler function in the base station determines with which radio communication terminal is to communicate in each division unit time. Basically, as high a transmission rate as possible is decided on the basis of a DRC sent from each radio communication terminal and is used for a communication with it.

With the above configuration, the EV-DO system enables a maximum transmission rate of 2.4 Mbps (mega-bits per second) per sector in a downstream channel. This transmission rate is the sum of amounts of data communications from one base station to a plurality of radio communication terminals in one frequency band and in one of a plurality of sectors (usually, a plurality of sectors exist). The transmission rate increases if a plurality of frequency bands are used.

JP-A-2002-300644 is known as a related art.

A cellular phone of cdma2000 1x, etc., has identification information such as subscriber information unique to each terminal assigned by a common carrier, etc., generally for the purposes of valid connection to a radio telephone network, charging management, and the like. Such subscriber information is usually written into the terminal in the shop when the cellular phone is sold. Before the subscriber information is written, for example, one end of a serial communication line to enter the subscriber information is connected to a 16-condcutor connector provided at a terminal of a PDC or an 18-conductor connector provided at a terminal of cdmaOne or cdma2000 1x, and the other end of the serial communication line is connected to a personal computer (PC), etc. Further, communications are performed between the PC, etc., and the terminal according to a predetermined procedure, and the operator, etc., of the common carrier writes the subscriber information into the terminal.

Since the EV-DO is mainly intended for data communications, a PC or a PDA is excellent in operability rather than a cellular phone as the form of a terminal used by the user. Particularly, the PDA is generally small and is excellent not only in operability but also in portability. To realize such a form, for example, a communication module of a rectangle with one side about several centimeters and having a thickness of about several millimeters to ten several millimeters and having a communication function of the EV-DO is included in the PDA.

It is difficult to provide a coupling connector for writing subscriber information to the communication module with the communication module because of size restriction of these. It is necessary to supply power to the communication module in order to write the subscriber information into the communication module, or the subscriber information cannot be written into the communication module without the power supply. Therefore, the communication module is taken out from the PDA and is placed in a writer of subscriber information and after the subscriber information is written into the communication module, the communication module is taken out from the writer and is again installed in the PDA. This procedure is intricate and at the same time, there is a fear of degrading the reliability of the connection of a board of the PDA and the communication module because the communication module is detached from and again attached to the PDA.

A connection terminal of the coupling connector may be provided at the main body of the PDA to connect the connection terminal and the communication module by a signal line. However, since the size of the PDA is small, preferably the area occupied by the signal line in the PDA should be smaller. If the signal line is also connected to a CPU of the PDA, there is a possibility that the subscriber information may be entered in the CPU. In such a case, it is also feared that the subscriber information may be abused. Therefore, a configuration to prevent the signal line from being input to the CPU is required from the viewpoints of security and management of the common carrier.

### SUMMARY OF THE INVENTION

The object of the invention is to provide an information processing device provided with a terminal for externally inputting a predetermined information for enabling the information to be input to a communication module with safety.

The invention provides an information processing device, having: a connection terminal, which is connected to a first signal line, to connect an external device to the information processing device; a control section, which is connected to a second signal line whose transfer speed is different from a transfer speed of the first signal line, for performing various processes of the information processing device; a communication section, which is connected to a third signal line to be connected the first signal line or the second signal line, for performing a communication process based on a subscriber information; and a switching section for switching a connection of the third signal line to one of the first signal line and the second signal line, wherein the switching section connects the third signal line to the first signal line when the external device is connected to the connection terminal so that the subscriber information enables to be input from the external device, and connects the third signal line to the second signal line when the communication section performs the communication process.

The term “switch” may include the case where the connection is switched by a physical switch and the case where the connection is switched by a logical or electronic switch; a predetermined input signal may be output to either.

According to the information processing device, when the subscriber information is stored in the communication section, the switch section connects the communication section and the connection terminal. Therefore, the subscriber information can be input only to the communication section. On the other hand, where communication is executed by the communication section, the control section is connected to the communication section through a signal line of a high transfer speed. Therefore, the signal transfer at the high speed can be realized.

The transfer speed of the second signal line may be higher than the transfer speed of the first signal line. The control section may output a signal for instructing the switching section to switch the connection of the third signal line, and the switching section may connect the third signal line to the first signal line or the second signal line according to the signal instructed the switching section to switch the connection of the third signal line. The information processing device may further has: a connection detecting section for detecting connection of the external device and the connection terminal, wherein the switching section may switch the connection of the third signal line according to a detection result of the connection detecting section.

The information processing device may further has: a power control section for controlling power supply to the control section, wherein the power control section may stop the power supply to the control section when the switching section connects the first signal line to the third signal line. The information processing device may further has: a power control section for controlling power supply to the control section, wherein when the power control section may start the power supply to the control section, the switching section may connect the second signal line to the third signal line, and when the power control section stops the power supply to the control section, the switching section may connect the first signal line to the third signal line. The information processing device may further have: a notification section for notifying a user of the information processing device of a predetermined message according to the connection of the third signal line. The communication section may be a communication module.

Conversion of any desired combination of the components described above and the representation of the invention among methods, apparatuses, systems, record media, computer programs, etc., is also effective as an aspect of the invention.

According to the invention, there can be provided the information processing device provided with a terminal for externally inputting a predetermined information for enabling the information to be input to a communication module with safety.

### BRIEF DESCRIPTION OF THE DRAWINGS

FIG. 1 is a block diagram to show the configuration of an information processing device according to a first embodiment of the invention;

FIGS. 2A and 2B are drawings to show the back and the face of the appearance of the information processing device in FIG. 1;

FIG. 3 is a drawing to show an example of display of a display section in FIG. 1;

FIG. 4 is a block diagram to show the configuration of an information processing device according to a second embodiment of the invention;

FIG. 5 is a block diagram to show the configuration of an information processing device according to a third embodiment of the invention;

FIG. 6 is a block diagram to show the configuration of an information processing device according to a fourth embodiment of the invention; and

FIG. 7 is a block diagram to show the configuration of an information processing device according to a fifth embodiment of the invention.

### DETAILED DESCRIPTION OF THE PREFERRED EMBODIMENTS

### First Embodiment

A first embodiment of the invention relates to an information processing device incorporating a communication module. The information processing device has a CPU for executing various processing other than a communication processing. Usually, if the user operates to execute a program stored in a storage area in the information processing device, the CPU executes processing of the program. On the other hand, if the user operates to execute the communication processing, the communication module conducts communications solely and thus the CPU transmits information to be communicated to the communication module via a signal line between the CPU and the communication module. The communication module stores subscriber information therein and uses the stored subscriber information in conducting communications.

Therefore, it is necessary to store the subscriber information in the communication module prior to communication processing. The information processing device of the embodiment has a switch section positioned between the CPU and the communication module. The switch section includes three terminals, two of which are respectively connected to the CPU and the communication module, and the remaining one is connected to a connection terminal provided on a cabinet of the information processing device. In usual processing, the switch section connects the CPU and the communication module. In writing subscriber information into the communication module, the switch section connects the connection terminal and the communication module. Consequently, the subscriber information is prevented from being transmitted to the CPU.

Between the communication module and the connection terminal, the subscriber information is only transferred so that high transfer speed is not required. On the other hand, between the communication module and the CPU, data to be communicated is transferred so that higher transfer speed is desired. Thus, if a plurality of signal lines are prepared for those, the number of the signal lines increases as well as the number of terminals for the signal lines attached to the communication module also increases. In the embodiment, signal lines are shared, the function of the signal lines is switched or changed or selected by the communication module according to the operation of the switch section.

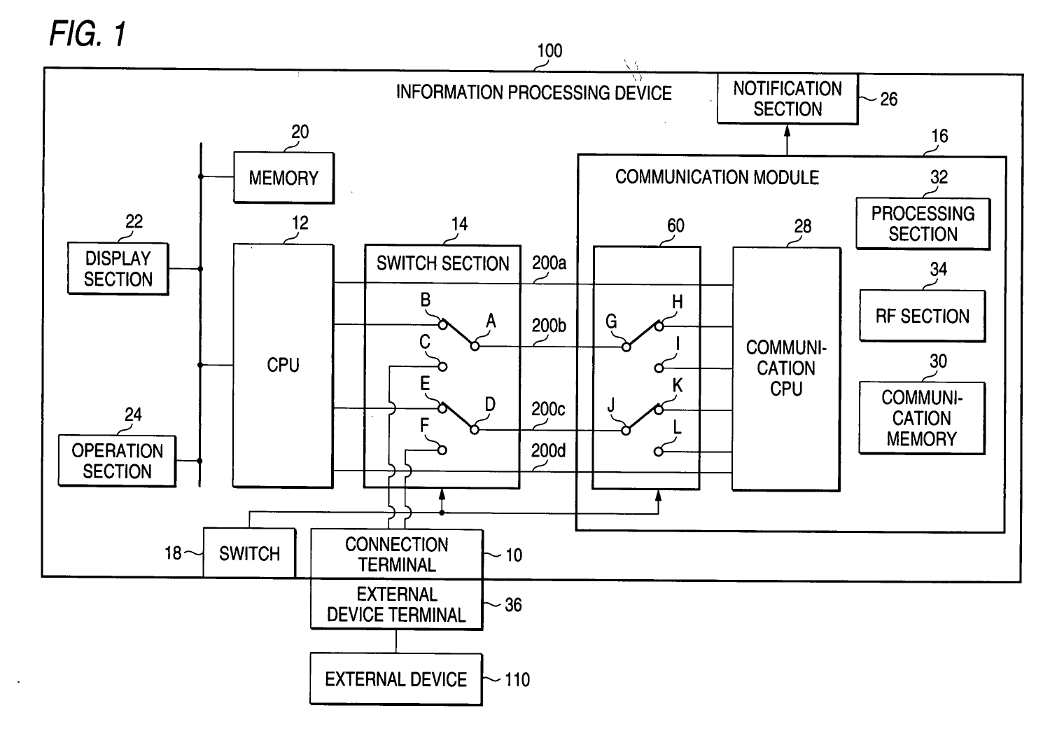

FIG. 1 shows the configuration of an information processing device 100 according to the first embodiment. The information processing device 100 includes a connection terminal 10, a CPU 12, a switch section 14, a switch 18, a memory 20, a display section 22, an operation section 24, and a notification section 26. The communication module 16 includes a communication CPU 28, communication memory 30, a processing section 32, an RF section 34, and an in-module switch section 60. The switch section 14 includes contacts A to F, and the in-module switch section 60 includes contacts G to L. The information processing device 100 also includes module signal lines 200 as signal lines. An external device 110 and an external device terminal 36 exist outside the information processing device. Further, a communication module 16 provided as a different unit from the information processing device 100 is connected with the information processing device 100.

The CPU 12 executes various processing that can be executed in the information processing device 100. Particularly, the CPU 12 executes a program stored in the memory 20 in conjunction with the memory 20. For example, the program is document preparation, schedule management, mail client, etc. The memory 20 may temporarily store the program or may store the program until the program is deleted according to a predetermined instruction.

The communication module 16 executes communication processing based on EV-DO or cdma2000 1x. The RF section 34 executes transmission and reception processing of a radio signal, the processing section 32 executes modulation and demodulation processing of a baseband signal, spread processing and inverse spread processing, error correction processing, retransmission processing, etc. The communication CPU 28 executes control processing in the RF section 34 and the processing section 32. Further, subscriber information such as a telephone number provided by a common carrier, etc., is stored in the communication memory 30, and is read particularly by the communication CPU 28 as required. The in-module switch section 60 operates in synchronization with the switch section 14 on the basis of an instruction from the switch 18.

The connection terminal 10 is an 18-conductor coupling connector defined for EV-DO and cdma2000 1x cellular phones, and includes an asynchronous serial communication signal line. For a cdmaOne, cdma2000 1x cellular phone communication terminal, two asynchronous serial communication signal lines are defined in an 18-conductor coupling connector, and one of the signal lines is used to write subscriber information. In the case of PDC, an asynchronous serial signal line is also defined in a 16-conductor coupling connector and is used to write subscriber information. A signal line with a higher speed than a USB signal line may be used in place of the asynchronous serial communication signal line.

The switch section 14 switches signal lines from the communication module 16 to the CPU 12 or the connection terminal 10. The switch section 14 can switch between connection of the CPU 12 and the communication module 16 and connection of the connection terminal 10 and the communication module 16. An explanation will be given of the connection of the signal lines among the CPU 12, the communication module 16 and the connection terminal 10 by the switch section 14 and the in-module switch section 60. The CPU 12 is coupled with four signal lines and the communication CPU 28 is coupled with six signal lines. A first module signal line 200a and a fourth module signal line 200d which are two lines of those signal lines correspond to VBUS (power source) and GND (grounding) directly coupling the CPU 12 and the communication CPU 28, respectively.

The switch section 14 includes terminals A to F. The terminals B and E coupled with the CPU 12 correspond to D+ and D− of a bi-directional signal line, respectively. Thus, if the terminal A is connected to the terminal B and the terminal D is connected to the terminal E, the module signal line 200 is identical to the USB signal line. On the other hand, the terminals C and F are coupled with the connection terminal 10, and correspond to T×D (transmission data line) and R x D (reception data line), respectively. Thus, if the terminal A is connected to the terminal C and the terminal D is connected to the terminal F, the module signal line 200 is identical to the asynchronous signal line. The in-module switch section 60 includes terminals G to L. The terminals H and K correspond to D+ and D− of the bi-directional signal line, respectively. The terminals I and L correspond to T×D (transmission data line) and R×D (reception data line), respectively.

An explanation will be given of the operation of the switch section 14 and in-module switch section 60 having the configurations described above. When a signal is transferred between the CPU 12 and the communication CPU 28, in the switch section 14, the terminals A and B are connected and the terminals D and E are connected, whereas in the in-module switch section 60, the terminals G and H are connected and the terminals J and K are connected. Thus, the module signal line 200 serves as the USB signal line. On the other hand, when the signal is transferred between the connection terminal 10 and the communication CPU 28, in the switch section 14, the terminals A and C are connected and the terminals D and F are connected, whereas in the in-module switch section 60, the terminals G and I are connected and the terminals J and L are connected. Thus, the module signal line 200 serves as the asynchronous serial signal line. In either case, the communication module 16 uses as an interface the module signal line 200 which includes four signal lines. Further, it is assumed that the module signal line 200 has a transfer speed varying according to the USB signal line or the asynchronous serial signal line. When the CPU 12 and the communication module 16 are connected or the connection terminal 10 and the communication module 16 are connected, the switch section 14 and in-module switch section 60 operate as described above, but this will not be explained in the following description.

The switch 18 has a function for the user to instruct the switching of the switch section 14 and the in-module switch section 60. That is, to use the communication module 16 with the CPU 12, the user operates the switch 18 so as to connect the communication module 16 and the CPU 1. To use the communication module 16 with the external device 110 connected to the connection terminal 10 through the external device terminal 36, the user operates the switch 18 so as to connect the communication module 16 and the connection terminal 10.

The display section 22 mainly displays the processing result of the CPU 12. It is a liquid crystal display, etc., by way of an example; it may be a main display or when the information processing device 100 is of folding type and has a sub-display, the display section 22 may be the sub-display. In the case that the connection terminal 10 and the communication module 16 are connected by the switch section 14 and the in-module switch section 60, the CPU 12 determines the state of the switch section 14 and displays a message to the effect that the function of the communication module 16 cannot be used from the CPU 12.

The operation section 24 is an interface for the user of the information processing device 100, and includes a keyboard, buttons, etc. The operation section 24 need not be hardware and may be a software keyboard, etc., displayed in the display section 22.

The notification section 26 is an LED, etc., controlled by the communication module 16. The notification section 26 can notify the user of the operation of the communication module 16 even if the CPU 12 is in a non-operating state. The notification section 26 notifies the user of the operation state of the communication module 16, such as operating/non-operating, communicating, or standby mode, blind spot, reception strength, etc., by color, on/off, blinking/non-blinking, blinking period, etc. With PCMCIA card type, etc., in a related art, an LED exists on the card, for example. However, if an LED is provided on the communication module 16 which is incorporated in the information processing device, the user cannot see the LED and thus the LED is provided on the cabinet of the information processing device 100 and is controlled from the communication module 16. If the information processing device 100 is off, the LED can be used.

Further, in the cdmaOne, cdma2000 1x cellular phone communication terminal, the control lines connected to the connection terminal 10 include a voice input/output (analog, single end) signal line in the 18-conductor coupling connector. A voice input/output terminal of the communication module 16 and a voice input/output signal terminal of the connection terminal 10 are connected, whereby the connection terminal 10 can be used not only for use of an asynchronous serial signal to write subscriber information, etc., but also for use of voice input/output as a hands-free unit, etc.

The configuration can be implemented by a CPU, memory, and other LSIs of any desired computer as hardware and can be implemented by a program having a programming management function loaded into the memory, etc., as software. However, in the drawing, the configuration made up of the connection terminal 10, the CPU 12, the switch section 14, the communication module 16, etc., is drawn. Therefore, it will be obvious to those skilled in the art that the functional blocks can be implemented in various modes of hardware only, software only, or combination thereof.

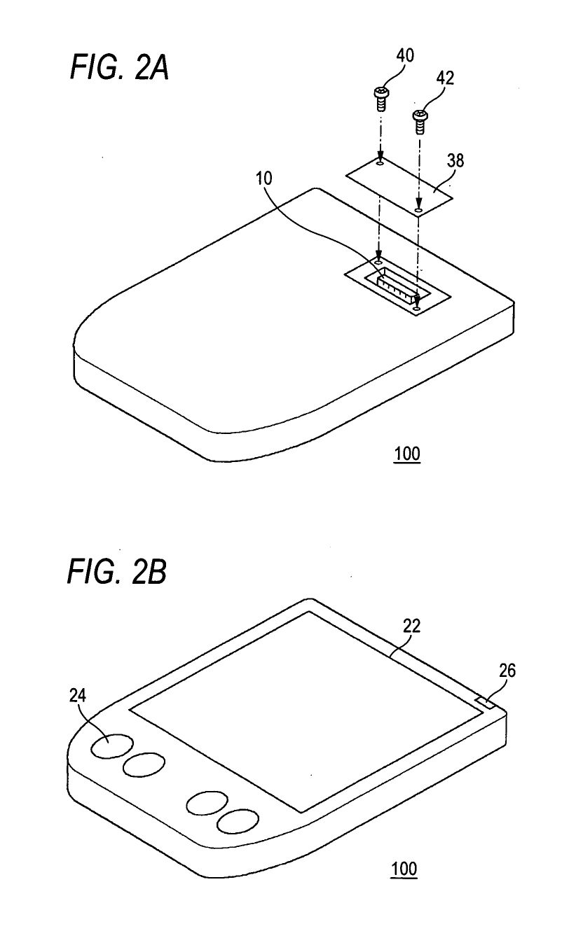

FIGS. 2A and 2B show the back and the face of the appearance of the information processing device 100. FIG. 2A shows the back of the information processing device 100. A lid 38, a first mounting screw 40, and a second mounting screw 42 are provided so as to cover the connection terminal 10. In the case that the connection terminal 10 is used not for the edition of telephone directory by a user or the connection with a PC but only for the terminal maintenance by a common carrier to write subscriber information, etc., the connection terminal 10 provided on the back or a side of the information processing device 100 is covered with the lid 38 and is fixed by the first mounting screw 40 and the second mounting screw 42. The first mounting screw 40 and the second mounting screw 42 are those similar to special screws used to prohibit the user from disassembling the device such as arrow-shaped or tamperproof-recess-shaped screws other than general plus or minus threads. FIG. 2B shows the face of the information processing device 100. The display section 22, the operation section 24, and the notification section 26 are provided on the face. If the connection terminal 10 is unnecessary for the user, the described structure can prevent the user from accidentally connecting a PC, etc., to the connection terminal 10. The configuration is not limited to the described structure and may be any if it prevents the user from accidentally connecting a PC, etc., to the connection terminal 10.

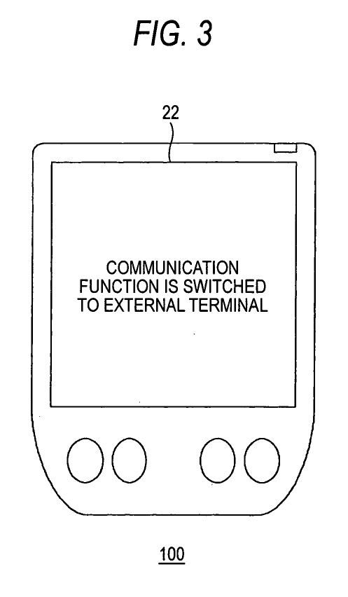

FIG. 3 shows an example of display of the display section 22. The display section 22 may produce display for enabling the user to recognize that the communication module 16 incorporated in the information processing device 100 cannot be used from the operation section 24, such as text display of “communication function is switched to external terminal” or the like or any desired icon display.

According to the embodiment, the signal line to input the subscriber information is shared with a part of the signal line used for communications in the information processing device 100, so that the area occupied by the signal line can be reduced. Further, since the transfer speed is varied according to the connecting format of the signal lines, the communication at a high transfer speed can be executed. Since the number of the terminals in the communication module 16 can be reduced, the circuit configuration can be simplified. Since the subscriber information input from the connection terminal 10 is not input to the CPU 12, safety is also ensured from the viewpoints of security. When the subscriber information is written, a message to the effect that the subscriber information is written is displayed on the display section 22, so that the user can easily recognize the operation. When the subscriber information is written, the notification section 26 notifies the user that the subscriber information is written, so that the user can easily recognize the operation even when the CPU 12 in the information processing device 100 is in halt.

### Second Embodiment

A second embodiment of the invention relates to an information processing device incorporating a communication module like the first embodiment. The second embodiment differs from the first embodiment in the switching methods of switch section and in-module switch section. If a connection terminal of an external device is connected to a connection terminal of the information processing device, it is detected and the switch section and the in-module switch section connect a communication module and the connection terminal of the information processing device. On the other hand, if connection of a connection terminal of an external device and the connection terminal of the information processing device is not detected, the switch section and the in-module switch section connect the communication module and the CPU.

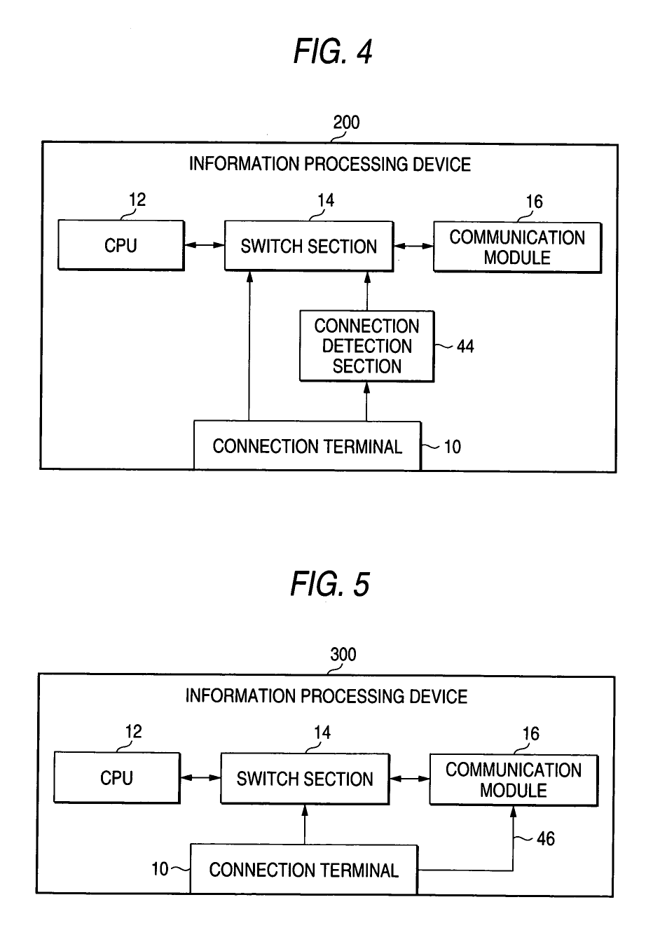

FIG. 4 shows the configuration of an information processing device 200 according to the second embodiment of the invention. A connection detection section 44 is added to the information processing device 200 in FIG. 4 as compared with the information processing device 100 in FIG. 1. In the information processing device 200 in FIG. 4, parts not relating to the description of the second embodiment, such as the notification section 26 of the information processing device 100 in FIG. 1, are not shown. In fact, the parts may exist.

The connection detection section 44 detects the external device terminal 36 of the external device 110 (not shown in FIG. 4) being inserted into the connection terminal 10. The switch section 14 connects the communication module 16 and the connection terminal 10 if the external device terminal 36 of the external device 110 is inserted based on the detection result of the connection detection section 44. Unless the external device terminal 36 of the external device 110 is inserted, the switch section 14 connects the communication module 16 and the CPU 12. Further, in synchronization with the connection in the switch section 14, the in-module switch section 60 (not shown) of the communication module 16 is connected as described above.

According to the embodiment, the switch section switches in association with connection of an external device 110, so that the number of work steps of write processing of subscriber information is decreased and it is made possible to facilitate the work.

### Third Embodiment

A third embodiment of the invention relates to an information processing device incorporating a communication module like the first embodiment. The third embodiment differs from the first embodiment in the switching methods of switch section and in-module switch section. An instruction terminal for accepting a subscriber information input instruction from an external device is provided in a connection terminal. To write subscriber information into the information processing device, the user operates an external device to transmit a subscriber information input instruction to the instruction terminal. Upon acceptance of the instruction, the switch section and the in-module switch section connect a communication module and the connection terminal. On the other hand, in a usual state, the switch section and the in-module switch section connect the communication module and a CPU.

FIG. 5 shows the configuration of an information processing device 300 according to the third embodiment of the invention. A control signal line 46 is added to the information processing device 300 in FIG. 5 as compared with the information processing device 100 in FIG. 1.

The control signal line 46 is a part of a signal line connected to a connection terminal 10 and is a control line for transmitting an instruction to write subscriber information into a communication module 16. The control signal line 46 is connected from the connection terminal 10 to the communication module 16. The communication module 16 of EV-DO system or cdma2000 1x system is controlled by two control signals 1 and 2, which are previously defined, in an 18-conductor coupling connector. The operation of the communication module 16 such as power forcible on, forcible off, or non-control is determined according to the state of the two control signals. Since power of the communication module 16 is turned on or off in response to the state of the control signal line 46, the external device 110 (not shown in FIG. 5) can control the operation of the communication module 16 via the control signal line 46 from the external device 110 regardless of whether or not the main unit of the information processing device 300 operates. For example, when the communication module 16 detects the instruction to write subscriber information transmitted through the connection terminal 10, the switch section 14 switches the connection of the communication module 16 to the connection terminal 10.

According to the embodiment, the switch section 14 and the in-module switch section 60 can switch from an external device 110, so that switch processing can be facilitated.

### Fourth Embodiment

A fourth embodiment of the invention relates to an information processing device incorporating a communication module like the first embodiment. In the fourth embodiment, if a switch section and an in-module switch section connect a communication module and a connection terminal by the method shown in the embodiments descried above, it is detected and power of a CPU is turned off. That is, power of only the parts required for write processing centering on the communication module is turned on during execution of subscriber information write processing by an external device.

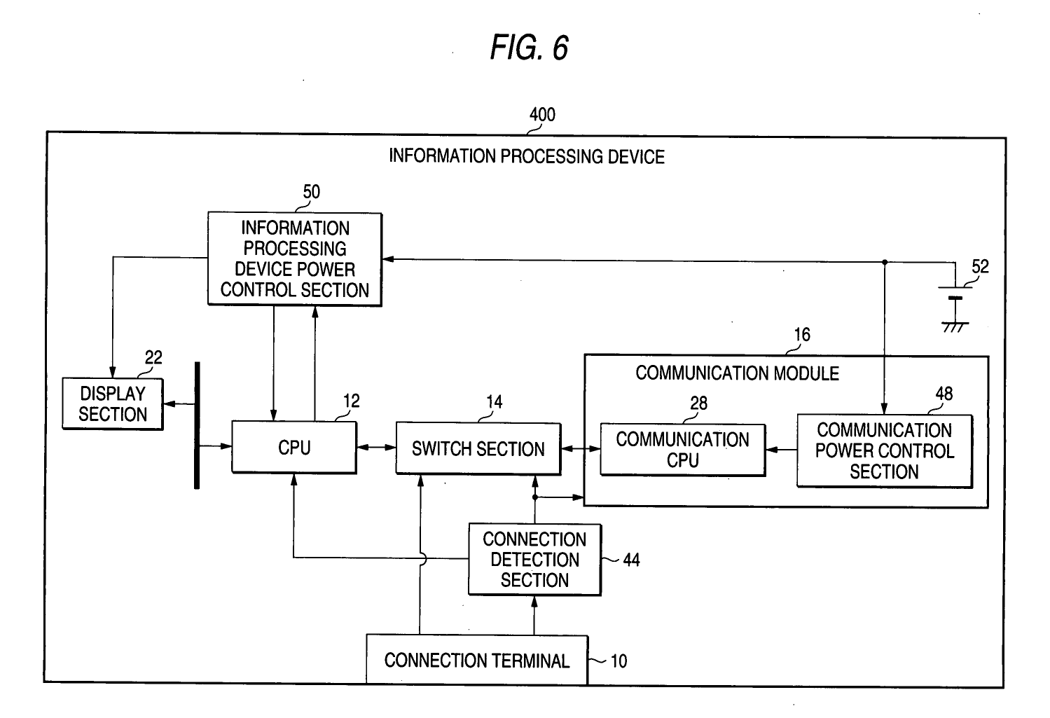

FIG. 6 shows the configuration of an information processing device 400 according to the fourth embodiment of the invention. A connection detection section 44, a communication power control section 48, an information processing device power control section 50, and a battery 52 are added to the information processing device 400 in FIG. 6 as compared with the information processing device 100 in FIG. 1.

The communication power control section 48 and the information processing device power control section 50 receive power supply from the battery 52 and control the power of a communication module 16 and a CPU 12. The communication module 16 incorporated in the information processing device 400 receives power supply from the battery 52 incorporated in the information processing device 400, and the communication power control section 48 and a communication CPU 28 in the communication module 16 control the power of the communication module 16. Similarly, the main unit of the information processing device 400 receives power supply from the battery 52, and the information processing device power control section 50 and the CPU 12 in the information processing device 400 control the power and the operation. The information processing device power control section 50 is controlled by the. CPU 12 and supplies the power to the CPU 12 and a display section 22.

For the information processing device 400 to conduct communications using the communication module 16, the communication power control section 48 of the communication module 16 supplies the power to the sections in the communication module 16 including the communication CPU 28, and the information processing device power control section 50 supplies the power to the CPU 12 and the display section 22, placing the main unit of the information processing device 400 and the communication module 16 in an operation state with the power supplied. On the other hand, to save power consumption of the battery 52, when the communication module 16 and the main unit of the information processing device 400 need not operate, power supply is controlled individually according to the decision of the communication CPU 28 in the communication module 16 and the CPU 12, and the operation is stopped or the current consumption is decreased in such a manner that power supply to an unnecessary part or the whole power supply is stopped.

More particularly, output of the connection detection section 44 controls switching of a switch section 14 and an in-module switch section 60 (not shown), and at the same time, is input to the CPU 12. The CPU 12 then determines the state of a connection terminal 10 based on the output of the connection detection section 44. When the external device terminal 36 from the external device 110 (not shown in FIG. 6) is inserted, namely, the communication module 16 and the connection terminal 10 are connected and the communication module 16 is directly controlled from the external device 110, the function of the main unit of the information processing device 400 is not required. Therefore, the information processing device power control section 50 is controlled for switching the main unit of the information processing device 400 into a current consumption decrease mode such as power off, sleep state, or power saving mode. Accordingly, when the external device 110 uses the communication module 16, unnecessary power consumption of the main unit of the information processing device 400 can be decreased.

The operation state to decrease the power consumption in the communication module 16 may include a complete function stop state in which power supply to the communication CPU 28 is stopped or an intermittent standby state in which the machine is started about once every several seconds with a timer and a radio reception state is monitored and if the home station is not called, other parts than the timer are placed in a sleep mode for decreasing average current consumption. The operation state to decrease the power consumption in the main unit of the information processing device 400 may include a complete function stop state in which power supply to the parts is stopped, a sleep state in which power is supplied only to the display section 22, a power saving mode in which the operation clock of the CPU 12, etc., is lowered for lessening the power consumption although power is supplied to the parts, or the like.

According to the embodiment, the power of the CPU 12 can be turned off to perform write processing of the subscriber information, so that low power consumption is made possible.

### Fifth Embodiment

A fifth embodiment of the invention relates to an information processing device incorporating a communication module like the first embodiment. The fifth embodiment differs from the first embodiment in the switching methods of switch section and in-module switch section. If power of a CPU is turned off, it is detected and the switch section and the in-module switch section connect a communication module and a connection terminal. On the other hand, in a usual state, the switch section connects the communication module and the CPU. The relationship between turning on or off power of the CPU and the switch timing of the switch section and the in-module switch section is opposite as compared with the fourth embodiment.

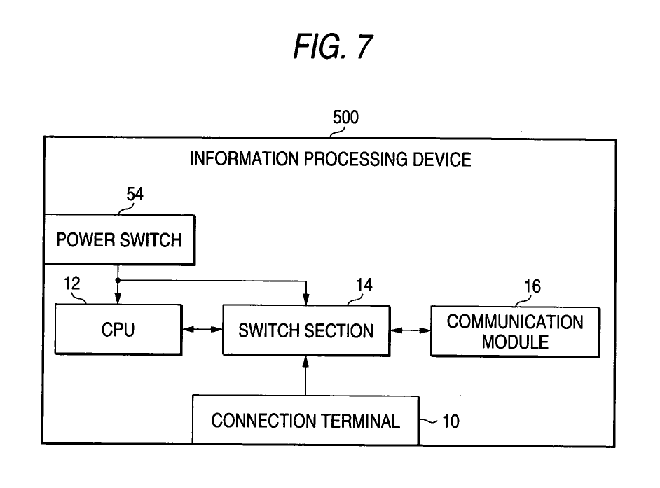

FIG. 7 shows the configuration of an information processing device 500 according to the fifth embodiment of the invention. A power switch 54 is added to the information processing device 500 in FIG. 7 as compared with the information processing device 100 in FIG. 1.

The power switch 54 is a switch of the main unit of the information processing device 500. In the embodiment, a switch section 14 and the in-module switch section 60 (not shown) are switched in association with the power switch 54. When power of the information processing device 500 is on, the switch section 14 switches to connect a communication module 16 and a CPU 12. When power of the information processing device 500 or the CPU 12 is off, the switch section 14 switches to connect the communication module 16 and a connection terminal 10. Accordingly, when the information processing device 500 is in a non-operating state, namely, when the communication module 16 and the CPU 12 need not conduct communications and an external device 110 (not shown in FIG. 7) uses the communication module 16, the communication module 16 can be used via the connection terminal 10 without any switch operation, etc by the user.

According to the embodiment, the power of the CPU 12 can be turned off to perform write processing of the subscriber information, so that low power consumption is made possible.

The invention has been described based on the embodiments. It is understood by those skilled in the art that the embodiments are illustrative and that various changes and modifications may be made in the invention without departing from the spirit and scope thereof.

In the first embodiment, the switch section 14 and the in-module switch section 60 are switched as the switch 18 is switched. However, the invention is not limited to it. For example, the switch section 14 may be switched based on user's operation for the CPU 12 through the operation section 24 or condition decision in the CPU 12. For example, if the user operates the operation section 24 so that the CPU 12 does not use the communication module 16, the switch section 14 switches to connect the communication module 16 and the connection terminal 10. If the user operates the operation section 24 so that the CPU 12 uses the communication module 16, the switch section 14 switches to connect the communication module 16 and the CPU 12. According to the modification, the switch 18 becomes unnecessary and the information processing device 100 can be furthermore miniaturized.

In the fifth embodiment, the switch section 14 and the in-module switch section 60 are switched as the power switch 54 is switched. However, the invention is not limited to it. For example, in the configuration in which turning on/off the power of the main unit of the information processing device 100, etc., is controlled through the operation section 24 in FIG. 1, when the user turns off the information processing device 100 through the operation section 24 or the CPU 12 autonomously causes the information processing device 100 to make a transition to a non-operating state, the switch section 14 and the in-module switch section 60 may connect the connection terminal 10 and the communication module 16 before the power is turned off. According to the modification, the power switch 54 becomes unnecessary and the information processing device 100 can be furthermore miniaturized.

In the first to fifth embodiments, the information processing devices 100 to 500 are for example PDA, but may be any other than PDA and may be PC. According to the modification, the invention can be applied to various information processing devices. That is, the information processing device may be any if it can process digitalized information.

The first embodiment can also be combined with any of the second to fifth embodiments. According to the combination, as the switch section 14 and the in-module switch section 60 switch, a predetermined message is displayed on the display section 22 and the notification section 26 provides the user with predetermined information in the second to fifth embodiments.

The fourth embodiment can also be combined with the second embodiment. According to the combination, the power of the CPU 12 is turned off in response to the state of the control signal line 46.

1. An information processing device comprising:
a connection terminal, which is connected to a first signal line, to connect an external device to the information processing device;
a control section, which is connected to a second signal line whose transfer speed is different from a transfer speed of the first signal line, for performing various processes of the information processing device;
a communication section, which is connected to a third signal line to be connected the first signal line or the second signal line, for performing a communication process based on a subscriber information; and
a switching section for switching a connection of the third signal line to one of the first signal line and the second signal line,
wherein the switching section connects the third signal line to the first signal line when the external device is connected to the connection terminal so that the subscriber information enables to be input from the external device, and connects the third signal line to the second signal line when the communication section performs the communication process.

2. The information processing device according to claim 1,
wherein the transfer speed of the second signal line is higher than the transfer speed of the first signal line.

3. The information processing device according to claim 1,
wherein the control section outputs a signal for instructing the switching section to switch the connection of the third signal line, and
the switching section connects the third signal line to the first signal line or the second signal line according to the signal instructed the switching section to switch the connection of the third signal line.

4. The information processing device according to claim 1, further comprising:
a connection detecting section for detecting connection of the external device and the connection terminal,
wherein the switching section switches the connection of the third signal line according to a detection result of the connection detecting section.

5. The information processing device according to claim 1, further comprising:
a power control section for controlling power supply to the control section,
wherein the power control section stops the power supply to the control section when the switching section connects the first signal line to the third signal line.

6. The information processing device according to claim 1, further comprising:
a power control section for controlling power supply to the control section,
wherein when the power control section starts the power supply to the control section, the switching section connects the second signal line to the third signal line, and
when the power control section stops the power supply to the control section, the switching section connects the first signal line to the third signal line.

7. The information processing device according to claim 1, further comprising:
a notification section for notifying a user of the information processing device of a predetermined message according to the connection of the third signal line.

8. The information processing device according to claim 1,
wherein the communication section is a communication module.
